(19) United States
(12) Patent Application Publication
(10) Pub. No.: US 2007/0259150 A1
(43) Pub. Date: Nov. 8, 2007

(54) Optical storage medium

(75) Inventor: Makoto Hirama, Ibaraki-Ken (JP)

Correspondence Address: RENNER KENNER GREIVE BOBAK TAYLOR & WEBER, FIRST NATIONAL TOWER FOURTH FLOOR, 106 S. MAIN STREET, AKRON, OH, 44308, US

(73) Assignee: Victor Company of Japan, Ltd., a corporation of Japan, Yokohama-Shi (JP)

(21) Appl. No.: 11/788,052

(22) Filed: Apr. 19, 2007

(30) Foreign Application Priority Data
Apr. 25, 2006 (JP) 2006-120618

(51) Int. Cl. B32B 7/00

(52) U.S. Cl. 428/64.4

(57) ABSTRACT

An optical storage medium has a substrate having a first surface and a second surface on both sides. Formed on the first substrate is a layer of at least a dielectric film, a recording film and a reflected film. Formed on the second surface is a hard coat layer that includes a hardened antistatic hard coat agent containing a hard coat agent and an ionic liquid as an antistatic agent.

### CROSS-REFERENCE TO RELATED APPLICATIONS

This application is based on and claims the benefit of priority from the prior Japanese Patent Application No. 2006-120618 filed on Apr. 25, 2006, the entire content of which is incorporated herein by reference.

### BACKGROUND OF THE INVENTION

The present invention relates to an optical storage medium having a substrate with a hard coat agent applied thereon. The invention, particularly, relates to an optical storage medium having a substrate with an antistatic hard coat agent applied thereon.

Optical storage media for which data are recorded or reproduced, such as, DVD-RW, have widely been used in a variety of fields. Substrate materials for such optical storage media are usually thermoplastic resins, such as, polymethylmethacrylate, polycarbonate, etc., for their excellent formability and optical characteristics.

These thermoplastic resins are excellent in mass producibility, formability and cost performance. Polycarbonate has, in particular, been used most as substrate materials for optical storage media for its comparatively high heat distortion temperature.

Substrates made of such a thermoplastic resin, however, have low surface hardness, thus prone to scratch and susceptible to static electricity. Optical storage media having a substrate made of such a thermoplastic resin could suffer errors in recording or reproduction when daily used because of scratches, dust due to static electricity, etc.

One solution for such problems may be a hard coat with a relatively high hardness to protect a substrate surface.

Japanese Unexamined Patent Publication No. 07(1995)-182692 discloses an optical disc and a method for producing the same. In detail, a hard coat agent is applied on a substrate by spin coating, after injection molding, to form a hard coat on a surface of the substrate. After the hard coat is formed, a dielectric film, a recording film, a reflective film, etc., are formed on the other surface of the substrate, in a vacuum film forming apparatus.

The inventor of the present invention produced an optical disc with a hard coat formed on a surface thereof according to the method above. It was found that a dielectric film formed on the other surface was thinner than that of an optical disc produced without a hard coat, even though the dielectric film and other films such as a recording film and a reflective film were formed according to the method.

An optical disc with a dielectric film having a thickness beyond a margin of ±5% of designed thickness cannot meet the requirements of reflectivity, modulation, overwrite characteristics, etc. It is thus required to form a dielectric film having a thickness within the margin of ±5% of designed thickness.

Possible solutions for the problem of a phenomenon in which a thinner dielectric film is formed on a substrate surface, with a hard coat formed on the other surface are: formation of a hard coat after a dielectric film; and a longer forming time for a dielectric film.

Hard-coat formation after a dielectric film, however, lowers yields than before a dielectric film, due to dust on a substrate during the film forming process. A longer dielectric-film forming time lowers production efficiency.

As clear from above, a film forming rate is lowered for a dielectric film when this film and other films are formed on a surface of a substrate after a hard coat is formed on the other surface. Yields lower when a hard coat is formed after a dielectric film. Moreover, production efficiency lowers when a dielectric-film forming time is extended.

### SUMMARY OF THE INVENTION

The purpose of the present invention is to provide an optical storage medium that exhibits higher scratch resistance and excellent antistatic property, produciable at a higher film-forming rate for each film formed on a surface of a substrate after a hard coat is formed on the other surface, with increased productivity.

The present invention provides an optical storage medium comprising: a substrate having a first surface and a second surface on both sides; a layer of at least a dielectric film, a recording film and a reflected film, formed on the first surface of the substrate; and a hard coat layer formed on the second surface of the substrate, the hard coat layer including a hardened antistatic hard coat agent containing a hard coat agent and an ionic liquid as an antistatic agent.

### BRIEF DESCRIPTION OF DRAWINGS

FIG. 1 is an enlarged cross section illustrating a layered structure of an embodiment of an optical storage medium according to the present invention;

FIG. 2 is a table listing the thickness and the film forming rate of a dielectric film formed on a recording film varied according to the moisture content of the hard coat agent;

FIG. 3 is a graph showing the film forming rate of the dielectric film varied according to the moisture content of the hard coat agent, based on the table in FIG. 2;

FIG. 4 is a table listing several measured results and evaluations on embodiment samples E1 to E9 according to the present invention and also comparative samples C1 to C4;

FIG. 5 is a photograph showing appearance change on the comparative sample C1 after left for 96 hours in an 80° C.-85% environment;

FIG. 6 is a photograph showing appearance change on the comparative sample C1 after left for 1000 hours in the 80° C.-85% environment;

FIG. 7 is a photograph showing appearance change on the embodiment sample E9 after left for 96 hours in the 80° C.-85% environment;

FIG. 8 is a photograph showing appearance change on the embodiment sample E9 after left for 1000 hours in the 80° C.-85% environment;

FIG. 9 is a photograph showing appearance change on the comparative sample C2 after left for 96 hours in the 80° C.-85% environment;

FIG. 10 is a photograph showing appearance change on the comparative sample C2 after left for 1000 hours in the 80° C.-85% environment; and

FIG. 11 is a graph showing change in surface electrical resistance on a hard coat layer of the optical storage medium shown in FIG. 1, according to each content of electroconductive agents used for the embodiment samples E1 to E9 and the comparative samples C1 to C4, based on the results in FIG. 4.

### DETAILED DESCRIPTION OF PREFERRED EMBODIMENT

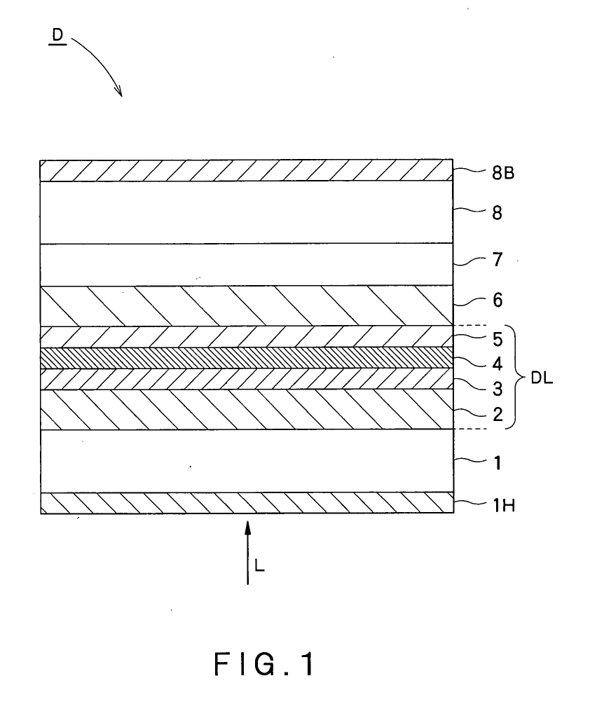

FIG. 1 shows an enlarged cross section illustrating an optical storage medium, a preferred embodiment according to the present invention.

Formed on a surface of a substrate 1 are: a first dielectric film 2 made of a transparent inorganic compound; a recording film 3 made of a phase-change material, such as an alloy, AgInSbTe; a second dielectric film 4 made of a transparent inorganic compound; and a reflective film 5 made of Al, an alloy of Ag, etc. The layer constituted by these films is referred to as a data layer DL for storing data, hereinafter.

Formed over the data layer DL is a substrate 8 having a protective film 6, and a bonding film 7 on one side and a surface 8B for labeling on the other side.

The substrate 1 is coated with a hard coat layer 1H on the other surface.

The hard coat layer 1H is formed, after the substrate 1 is formed, in such a way that a hard coat agent is applied on the other surface of the substrate 1, for example by spin coating, and then hardened with ultraviolet rays. The hard coat agent is applied as soon as possible after the substrate 1 is formed so that it is applied well with less dust attachment. The hard coat agent can be hardened with active energy rays, such as, ultraviolet rays and electron rays. Among them, radiation of ultraviolet rays is a feasible way to harden the hard coat agent, with less adverse effects to a recording film, etc., in low cost facility.

The hard coat agent used in this embodiment involves a resin material and a polymerization initiator, and optionally, several types of additives, such as, a polymerization inhibitor, a viscosity modifier, and an antioxidant. Radiation of ultraviolet rays for hardening the hard coat agent is performed with a polymerization initiator, such as, 1-hydroxycyclohexyl phenylketone, diethoxyacetophenone, and benzophenon. The amount of the polymerization initiator depends on the amount of ultraviolet rays to be radiated, the type of resin material to be used, etc.

To eliminate buildup of static electricity on the hard coat layer 1H, an ionic liquid is preferably added to the hard coat agent, as an antistatic agent (electroconductive material). An ionic liquid is a compound that consists of ions only, which is liquid at room temperature. It is also called room temperature molten salts.

Feasible candidates for the ionic liquid in this embodiment are an aliphatic ionic liquid, an imidazolium ionic liquid, etc., under consideration of how the optical storage medium D is used and where it is kept. Any other types of ionic liquid can also be selected under consideration of conductive effects, compatibility, storage stability, etc.

Studied for the optical storage medium D was how the moisture content of the hard coat agent used in this embodiment affected the film forming rate of the first dielectric film 2, one component of the medium D.

The resin material of the hard coat agent in this embodiment was composed of 62% by weight of pentaerythritol triacrylate, 21% by weight of isostearyl methacrylate, and 10% by weight of polytetramethyleneglycol diacrylate.

Additives were 6.5% by weight of Iruga Cure 500 (Nippon Ciba-Geigy, Co., Ltd.) and 0.5% by weight of t-butylhydro-quinone, as a photo-polymerization initiator and a polymerization inhibitor, respectively.

The resin material and the additives were fully stirred at 40° C. to be mixed with each other to prepare the hard coat agent in this embodiment. The hard coat agent contained 0.02% by weight of moisture because the resin material itself contained a tiny amount of moisture.

Iruga Cure is a trademark of Ciba Specialty Chemicals Holding Inc.

The optical storage medium D was produced as follows: The hard coat agent described above was applied on the substrate 1 for 3 seconds by spin coating at 8000 rpm. It was irradiated with ultraviolet rays, thus a 3.5-μm-thick hard coat layer 1H was formed on the substrate 1. The accumulated amount of radiation of ultraviolet rays was 1000 mj/cm².

The first dielectric film 2 was formed with ZnS.SiO₂ at an 80-nm thickness by sputtering on the other side of the substrate 1 coated with the hard coat layer 1H, followed by the recording film 3 with AgInSbTe at a 20-nm thickness, the second dielectric film 4 with ZnS.SiO₂ at a 20-nm thickness, and the reflective film 5 with Al at a 750-nm thickness, sputtered on the film 2 in this order. These four films constituted the data layer DL defined above.

The protective film 6 was formed with a UV-curable resin (SK5110, made by Sony Chemicals Co.) applied on the reflective film 5, at a 4-μm thickness, by spin coating, with ultraviolet rays at 1000 mj/cm² in the accumulated amount of radiation.

The substrate 1 and the substrate 8 produced in almost the same way as the substrate 1 were bonded to each other with the boding film 7 so that the protective film 6 faced with the other side of the substrate 8 having the surface 8B for labeling.

Accordingly, the optical storage medium D was produced with the substrate 1, the data layer DL, the protective film 6, the boding film 7, and the substrate 8, formed as disclosed above.

Each film was formed by a film forming apparatus (Type: DVD sprinter, made by Unaxis Co.) at a tact time of 4 seconds. The thickness of the first dielectric film 2 was measured by a film thickness measuring equipment (Type: η, made by STEAG ETA-Optik GmbH.). The moisture content of the hard coat agent was measured by a moisture meter (Type: MS-70, made by A & D Co.).

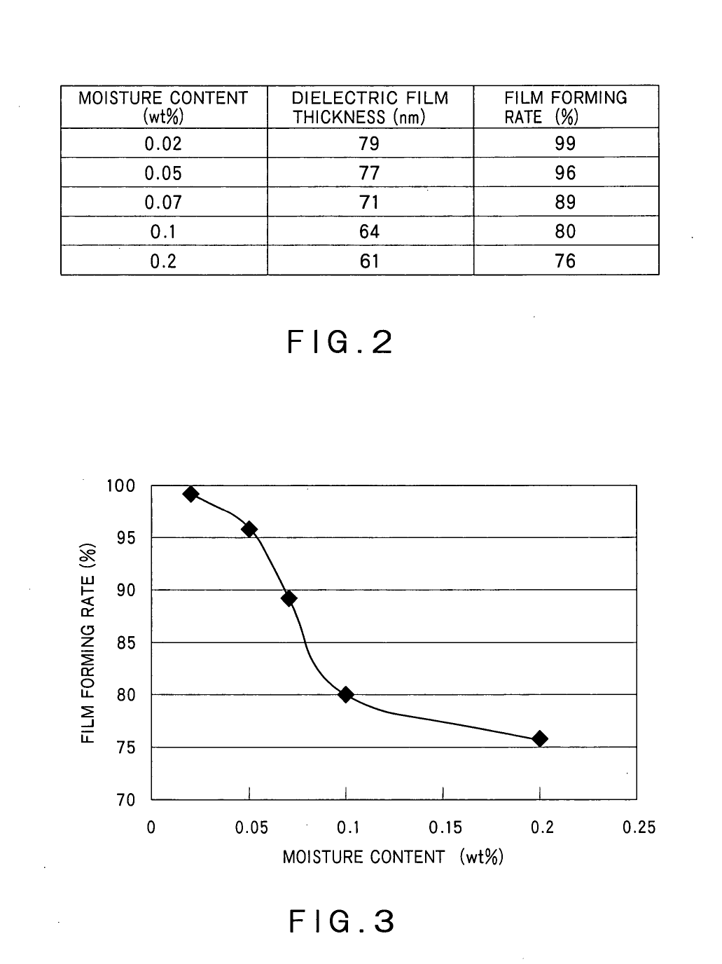

FIG. 2 shows the thickness and the film forming rate of the first dielectric film 2 varied according to the moisture content of the hard coat agent. FIG. 3 shows the film forming rate of the first dielectric film 2 varied according to the moisture content of the hard coat agent, based on the table in FIG. 2.

The moisture content of the hard coat agent was varied by adding water to 150 grams in weight of the agent prepared as described above, with a microsyringe.

As shown in FIG. 2, the moisture content was 0.02% by weight (wt %) when no water was added to the hard coat agent. This was the moisture content of the resin material itself contained in the hard coat agent. The moisture content was varied to 0.05%, 0.07%, 0.10%, and 0.20% by weight when water was added by 45 μl, 80 μl, 125 μl, and 280 μl, respectively.

There was almost no decrease in moisture in the hard coat layer 1H because the layer 1H was formed with the hard coat agent applied on the substrate 1 and irradiated with ultraviolet rays, in this embodiment. Thus, the hard coat layer 1H contained moisture at almost the same moisture content as the hard coat agent.

The film forming rate of the first dielectric film 2 shown in FIGS. 2 and 3 is the ratio of the thickness of the film 2 actually formed to 80 nm, the designed thickness. It is thus 100% if the film 2 was formed at 80 nm in thickness.

FIGS. 2 and 3 show that the moisture content of the hard coat agent at 0.05% by weight or lower gives 96% or higher for the film forming rate of the first dielectric film 2, which provides a margin of ±5% of the designed thickness of 80 nm. In contrast, 0.07% by weight or higher in moisture content gives 89% or lower for the forming rate of the film 2, resulting in a bigger error in thickness to the designed thickness.

It is found that the moisture content of the hard coat agent at 0.05% by weight or lower provides a margin of ±5% of the designed thickness of 80 nm to the first dielectric film 2 formed on the other surface of the substrate 1 coated with the hard coat layer 1H, which further provides excellent reflectivity, modulation, overwrite characteristics, etc.

The antistatic effect of the hard coat layer 1H was evaluated using an ionic liquid as an antistatic agent, explained above, added to the hard coat agent of this embodiment. It was evaluated by measuring a surface electrical resistance R1 of the hard coat layer 1H and another surface electrical resistance R2 of the layer 1H after the surface was wiped. It is known that 1×10¹⁴ Ω or lower for both of the resistances R1 and R2 give a sufficient antistatic effect.

The electrical resistances R1 and R2 were measured for embodiment samples E1 to E4 of the optical storage medium D according to the present invention and a comparative sample C1 of the medium D, produced with the hard coat layer 1H formed on one surface of the substrate 1 with a variety of antistatic agents added to the hard coat agent.

The hard coat layer 1H of each sample was wiped 10 times on the surface with a 50-50 water-alcohol liquid mixture.

Each sample was left in a high temperature and humidity environment of 80° C. and 85% (referred to as an 80° C.-85% environment, hereinafter) for 96 hours.

Observed were an appearance change A1 for each sample after being left for 96 hours and another appearance change A2 after being left for 1000 hours, in the 80° C.-85% environment.

Discussed below are how the hard coat layer 1H was formed for each sample and the evaluation of the sample in electrical resistance and appearance change.

### Embodiment Sample E1

The hard coat layer 1H was formed with an antistatic hard coat agent containing 3% by weight of an ionic liquid, prepared by fully mixing 97% by weight of the hard coat agent of the embodiment and 3% by weight of an ionic liquid, N,N-diethyl-N-methyl (2-methoxyethyl) ammonium bis (trifluoromethanesulfonyl) imide (referred to as an electroconductive agent EA1, hereinafter), as an antistatic agent.

This antistatic hard coat agent had a moisture content of 0.02% by weight, with almost no increase in moisture content due to addition of the ionic liquid.

Each ratio (% by weight) of the hard coat agent and the electroconductive agent is the ratio of the corresponding agent to the total weight of the antistatic hard coat agent, in this embodiment.

The antistatic hard coat layer 1H of this embodiment is formed with the antistatic hard coat agent applied on the substrate 1 and hardened with irradiation of ultraviolet rays, thus almost no decrease in moisture, as described above. Thus, the hard coat layer 1H contains moisture at almost the same moisture content as the applied hard coat agent. Each ratio of the hard coat agent and the electroconductive agent also remains unchanged after the hard coat layer 1H is formed.

The embodiment sample E1 coated with the hard coat layer 1H, as described above, exhibited 6.5×10¹⁰Ω in electrical resistance R1 on the layer 1H and 6.8×10¹⁰Ω in electrical resistance R2 thereon after wiped 10 times with the liquid mixture of water and alcohol. Both of the resistances R1 and R2 were lower than 1×10¹⁴Ω, thus giving a sufficient antistatic effect.

Moreover, the embodiment sample E1 exhibited almost no change in appearance change A1 after being left for 96 hours and also appearance change A2 after being left for 1000 hours, in the 80° C.-85% environment.

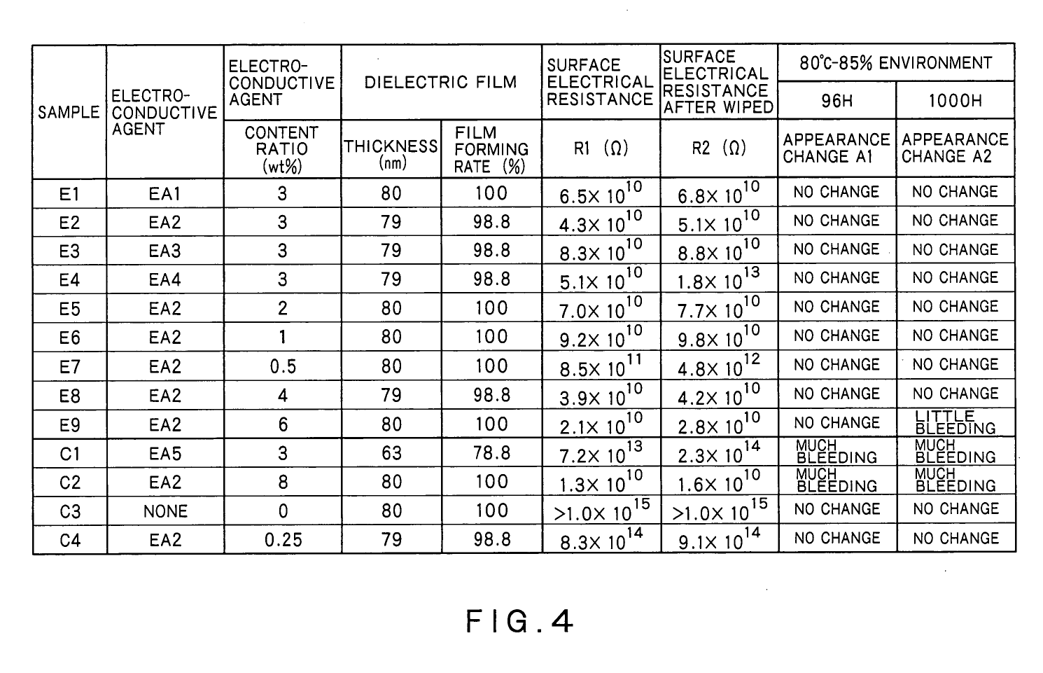

The results are shown in FIG. 4, with those for the embodiment samples E2 to E4 and the comparative sample C1, and also embodiment samples E5 to E9 and comparative samples C2 to C4, which will be discussed later.

Also shown in FIG. 4 are the thickness and the film forming rate of the first dielectric film 2. Moreover, in FIG. 4, “NO CHANGE” in appearance change means there is almost no change.

### Embodiment Sample E2

The hard coat layer 1H was formed with an antistatic hard coat agent containing 97% by weight of the hard coat agent of the embodiment and 3% by weight of an ionic liquid, trioctylmethyl ammonium bis (trifluoromethanesulfonyl) imide (referred to as an electroconductive agent EA2, hereinafter). The antistatic hard coat agent had a moisture content of 0.02% by weight.

The embodiment sample E2 coated with the hard coat layer 1H, as described above, exhibited electrical resistances R1 and R2 both lower than 1×10¹⁴Ω on the layer 1H, thus giving a sufficient antistatic effect, and almost no change in appearance changes A1 and A2.

### Embodiment Sample E3

The hard coat layer 1H was formed with an antistatic hard coat agent containing 97% by weight of the hard coat agent of the embodiment and 3% by weight of an ionic liquid, 1-ethyl-3-methylimidazodium tetrafluoromethane sulfonate (referred to as an electroconductive agent EA3, hereinafter). The antistatic hard coat agent had a moisture content of 0.02% by weight.

The embodiment sample E3 coated with the hard coat layer 1H, as described above, exhibited electrical resistances R1 and R2 both lower than 1×10¹⁴Ω on the layer 1H, thus giving a sufficient antistatic effect, and almost no change in appearance changes A1 and A2.

### Embodiment Sample E4

The hard coat layer 1H was formed with an antistatic hard coat agent containing 97% by weight of the hard coat agent of embodiment and 3% by weight of an ionic liquid, trioctylmethyl ammonium tetrafluoroborate (referred to as an electroconductive agent EA4, hereinafter). The antistatic hard coat agent had a moisture content of 0.02% by weight.

The embodiment sample E4 coated with the hard coat layer 1H, as described above, exhibited electrical resistances R1 and R2 both lower than 1×10¹⁴Ω on the layer 1H, thus giving a sufficient antistatic effect, and almost no change in appearance changes A1 and A2.

### Comparative Sample C1

The hard coat layer 1H was formed with an antistatic hard coat agent containing 3% by weight of quaternary ammonium salt, prepared by fully mixing 97% by weight of the hard coat agent of the embodiment and 3% by weight of quaternary ammonium salt, N,N-diethylaminopropyl acrylamido (referred to as an electroconductive agent EA5, hereinafter). The antistatic hard coat agent had a moisture content of 0.15% by weight.

The comparative sample C1 coated with the hard coat layer 1H, as described above, exhibited an electrical resistance R1 lower than 1×10¹⁴Ω on the layer 1H, but an electrical resistance R2 higher than 1×10¹⁴Ω thereon after wiped, thus giving an insufficient antistatic effect.

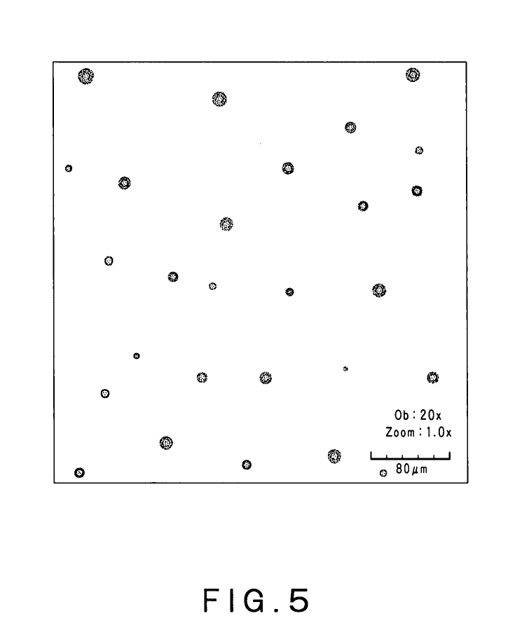

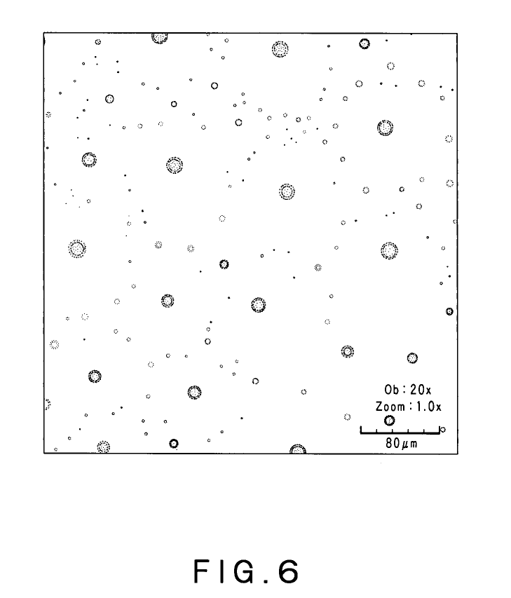

Moreover, much bleeding was observed on the comparative sample C1 in appearance changes A1 and A2, as shown in FIGS. 5 and 6, respectively, in the 80° C.-85% environment.

FIG. 4 shows that the embodiments samples E1 to E4 exhibited the surface electrical resistances R1 that gave a sufficient antistatic effect on the respective hard coat layers 1H with the antistatic hard coat agents containing 3% by weight of the electroconductive agents EA1 to EA4, respectively, compared to the comparative sample C1 with the electroconductive agent EA5.

Among them, the embodiment sample E2 having the hard coat layer 1H formed with the hard coat agent containing the electroconductive agent EA2 exhibited the lowest electrical resistance R1 and also the lowest electrical resistance R2 after wiped.

Discussed next are the embodiment samples E5 to E9 and the comparative samples C2 to C4.

Antistatic hard coat agents were prepared for the samples E5 to E9 and C2 to C4 with different amounts of the electroconductive agent EA2 that gave the lowest electrical resistances R1 and R2, as antistatic agents added to the hard coat agents.

The hard coat layer 1H was formed on one surface of the substrate 1, with each antistatic hard coat agent prepared as described above. Then, the data layer DL, the protective film 6, the boding layer 7, and the substrate 8 were formed on the other surface of the substrate 1, as described with reference to FIG. 1. Thus, the optical storage medium D was produced as each of the embodiment samples E5 to E9 and the comparative samples C2 to C4.

The embodiment samples E5 to E9 and the comparative samples C2 to C4 were evaluated for the surface electrical resistances R1 and R2 and the appearance changes A1 and A2, in the same way as described above.

It is found so far that the hard coat layer 1H with the antistatic hard coat agent containing 3% by weight of any one of the electroconductive agents EA1 to EA4 exhibits a sufficiently low surface electrical resistance R1. Thus, all of the electroconductive agents EA1 to EA4 are a useful antistatic agent in hard coating.

### Embodiment Sample E5

The hard coat layer 1H was formed with an antistatic hard coat agent containing 2% by weight of an ionic liquid, prepared by fully mixing 98% by weight of the hard coat agent of the embodiment and 2% by weight of the electroconductive agent EA2. The antistatic hard coat agent had a moisture content of 0.02% by weight.

The embodiment sample E5 coated with the hard coat layer 1H, as described above, exhibited electrical resistances R1 and R2 both lower than 1×10¹⁴Ω on the layer 1H, thus giving a sufficient antistatic effect, and almost no change in appearance changes A1 and A2 in the 80° C.-85% environment.

### Embodiment Sample E6

The hard coat layer 1H was formed with an antistatic hard coat agent containing 1% by weight of an ionic liquid, prepared by fully mixing 99% by weight of the hard coat agent of the embodiment and 1% by weight of the electroconductive agent EA2. The antistatic hard coat agent had a moisture content of 0.02% by weight.

The embodiment sample E6 coated with the hard coat layer 1H, as described above, exhibited electrical resistances R1 and R2 both lower than 1×10¹⁴Ω on the layer 1H, thus giving a sufficient antistatic effect, and almost no change in appearance changes A1 and A2 in the 80° C.-85% environment.

### Embodiment Sample E7

The hard coat layer 1H was formed with an antistatic hard coat agent containing 0.5% by weight of an ionic liquid, prepared by fully mixing 99.5% by weight of the hard coat agent of the embodiment and 0.5% by weight of the electroconductive agent EA2. The antistatic hard coat agent had a moisture content of 0.02% by weight.

The embodiment sample E7 coated with the hard coat layer 1H, as described above, exhibited electrical resistances R1 and R2 both lower than 1×10¹⁴Ω on the layer 1H, thus giving a sufficient antistatic effect, and almost no change in appearance changes A1 and A2 in the 80° C.-85% environment.

### Embodiment Sample E8

The hard coat layer 1H was formed with an antistatic hard coat agent containing 4% by weight of an ionic liquid, prepared by fully mixing 96% by weight of the hard coat agent of the embodiment and 4% by weight of the electroconductive agent EA2. The antistatic hard coat agent had a moisture content of 0.02% by weight.

The embodiment sample E8 coated with the hard coat layer 1H, as described above, exhibited electrical resistances R1 and R2 both lower than 1×10¹⁴Ω on the layer 1H, thus giving a sufficient antistatic effect, and almost no change in appearance changes A1 and A2 in the 80° C.-85% environment.

### Embodiment Sample E9

The hard coat layer 1H was formed with an antistatic hard coat agent containing 6% by weight of an ionic liquid, prepared by fully mixing 94% by weight of the hard coat agent of the embodiment and 6% by weight of the electroconductive agent EA2. The antistatic hard coat agent had a moisture content of 0.02% by weight.

The embodiment sample E9 coated with the hard coat layer 1H, as described above, exhibited electrical resistances R1 and R2 both lower than 1×10¹⁴Ω on the layer 1H, thus giving a sufficient antistatic effect.

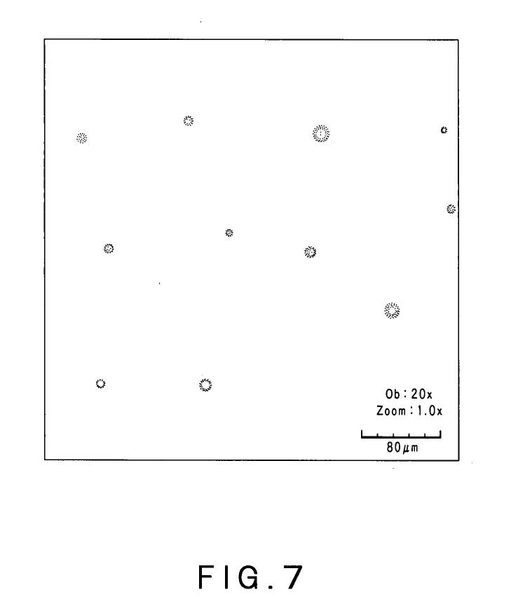

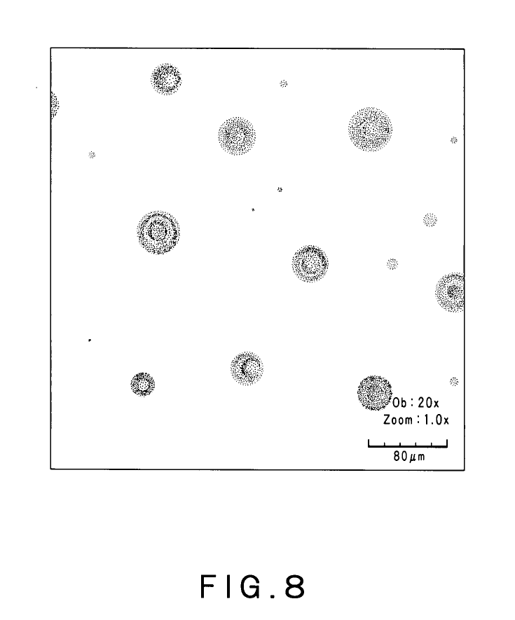

Almost no change was observed, as shown in FIG. 7, in appearance change A1 whereas bleeding was observed a little, as shown in FIG. 8, in appearance changes A2, on the embodiment sample E9, in the 80° C.-85% environment.

### Comparative Sample C2

The hard coat layer 1H was formed with an antistatic hard coat agent containing 8% by weight of an ionic liquid, prepared by fully mixing 92% by weight of the hard coat agent of the embodiment and 8% by weight of the electroconductive agent EA2. The antistatic hard coat agent had a moisture content of 0.02% by weight.

The comparative sample C2 coated with the hard coat layer 1H, as described above, exhibited electrical resistances R1 and R2 both lower than 1×10¹⁴Ω on the layer 1H, thus giving a sufficient antistatic effect.

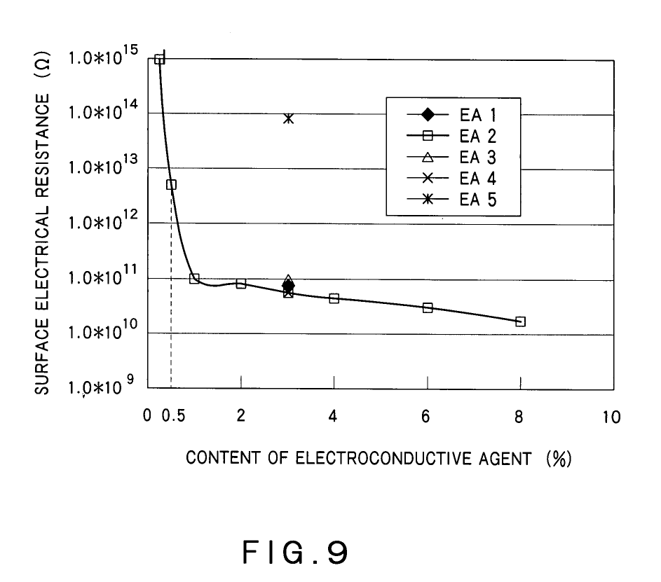

Much bleeding was observed, as shown in FIGS. 9 and 10, in appearance changes A1 and A2, respectively, on the comparative sample C2, in the 80° C.-85% environment.

### Comparative Sample C3

The hard coat layer 1H was formed with the hard coat agent of the embodiment but containing no antistatic agent. The hard coat agent had a moisture content of 0.02% by weight.

The comparative sample C3 coated with the hard coat layer 1H, as described above, exhibited electrical resistances R1 and R2 both higher than 1×10¹⁴Ω on the layer 1H, thus giving an insufficient antistatic effect.

In contrast, almost no change was observed in appearance changes A1 and A2, on the comparative sample C3, in the 80° C.-85% environment.

### Comparative Sample C4

The hard coat layer 1H was formed with an antistatic hard coat agent containing 0.25% by weight of an ionic liquid, prepared by fully mixing 99.75% by weight of the hard coat agent of the embodiment and 0.25% by weight of the electroconductive agent EA2. The antistatic hard coat agent had a moisture content of 0.02% by weight.

The comparative sample C4 coated with the hard coat layer 1H, as described above, exhibited electrical resistances R1 and R2 both higher than 1×10¹⁴Ω on the layer 1H, thus giving an insufficient antistatic effect.

In contrast, almost no change was observed in appearance changes A1 and A2, on the comparative sample C4, in the 80° C.-85% environment.

FIG. 11 shows change in surface electrical resistance R1 on the hard coat layer H1 according to each content of the electroconductive agents EA1, EA2, EA3, EA4 or EA5, for the embodiment samples E1 to E9 and the comparative samples C1 to C4, based on the results in FIG. 4.

FIG. 11 teaches that the content lower than 0.5% by weight for the electroconductive agent EA2 (an ionic agent) gives the hard coat layer 1H the surface electrical resistance R1 higher than 1×10¹⁴Ω.

For example, the comparative samples C3 and C4 having the antistatic hard coat agent with the electroconductive agent EA2 at the content lower than 0.5% by weight exhibited electrical resistances R1 and R2 both higher than 1×10¹⁴Ω on the hard coat layer 1H. Such hard coat layers cannot provide a sufficient antistatic effect.

FIG. 11 also teaches that the content of or higher than 0.5% by weight for the electroconductive agent EA2 gives the hard coat layer 1H the surface electrical resistance R1 lower than 1×10¹⁴Ω. Such hard coat layers can provide a sufficient antistatic effect.

Nevertheless, a too much higher content of the electroconductive agent EA2, such as 8% by weight for the comparative sample C2, causes change in appearance in the 80° C.-85% environment. Much bleeding was observed for the comparative sample C2 in the appearance change A2, as shown in FIG. 9 after the sample C2 was left for 1000 hours in the 80° C.-85% environment. Much bleeding causes higher error rate and also higher tracking error, resulting in low quality recording or reproduction performance.

A little bleeding was observed, as shown in FIG. 7, for the embodiment sample E9 with the antistatic hard coat agent containing 6% by weight of the electroconductive agent EA2. This degree of bleeding, however, gives very small adverse effects to recording or reproduction.

An antistatic hard coat agent containing quaternary ammonium salt (known as an electroconductive agent), such as in the comparative sample C1, exhibits a moisture content of 0.15% by weight, much higher than 0.05% by weight, due to the fact that quaternary ammonium salt exhibits higher hygroscopicity than an ionic liquid.

Moreover, the comparative sample C1 exhibited 78.8% in film forming rate for the first dielectric film 2, as shown in FIG. 4, which is out of the margin of ±5% of the designed thickness of 80 nm.

Furthermore, as shown in FIGS. 5 and 6, much bleeding was observed on the comparative sample C1 in appearance changes A1 and A2, after the sample C1 was left for 96 hours and 1000 hours, respectively, in the 80° C.-85% environment.

As discussed in detail, for the optical storage medium D in this embodiment, the content of an ionic liquid as an antistatic agent (electroconductive agent) in the range from 0.5% by weight to 6% by weight to the total weight of an antistatic hard coat agent gives 1×10¹⁴Ω or lower in surface electrical resistance R1 on the hard coat layer 1H and also surface electrical resistance R2 on the layer 1H after wiped, thus providing a sufficient antistatic effect.

The above range for the content of an ionic liquid as an antistatic agent further gives almost no change or no bleeding in appearance changes A1 and A2 after the optical storage medium D was left for 96 hours and 1000 hours, respectively, in the 80° C.-85% environment.

The optical storage medium D in this embodiment is a rewritable optical storage medium, employing a phase-change material for the recording film 3. Not only to such a rewritable optical storage medium, however, the hard coat agent of the embodiment can be applied to other optical storage media, such as, a write-once optical storage medium with a pigment for the recording film and a read-only optical storage medium.

As disclosed above, in the present invention, decrease in the film forming rate is much restricted for each film of the optical storage medium D even if each film is formed on one surface of the medium D after the hard coat layer is formed on the other surface thereof, thus higher productivity, scratch resistance and antistatic effects being achieved.

What is claimed is:

1. An optical storage medium comprising:
a substrate having a first surface and a second surface on both sides;
a layer of at least a dielectric film, a recording film and a reflected film, formed on the first surface of the substrate; and
a hard coat layer formed on the second surface of the substrate, the hard coat layer including a hardened antistatic hard coat agent containing a hard coat agent and an ionic liquid as an antistatic agent.

2. The optical storage medium according to claim 1, wherein the hard coat agent has 0.05% by weight or lower in moisture content.

3. The optical storage medium according to claim 1, wherein the antistatic agent is contained in a content ratio from 0.5% by weight to 6% by weight to the antistatic hard coat agent.
